(19) United States
(12) Patent Application Publication
(10) Pub. No.: US 2007/0012246 A1
(43) Pub. Date: Jan. 18, 2007

(54) Coating applicator apparatus for rotary sheet fed printing presses

(76) Inventor: Max W. Hess, Keller, TX (US)

Correspondence Address: Max W. Hess, 11824 Hickory Circle, Keller, TX, 76248, US

(21) Appl. No.: 11/180,962

(22) Filed: Jul. 14, 2005

(51) Int. Cl. B05C 1/00; B05C 1/08

(52) U.S. Cl. 118/231; 118/261

(57) ABSTRACT

A coating applicator apparatus applies coating upon a sheet substrate that is being transported by a sheet-carrying cylinder in a rotary sheet fed printing press. The coating applicator apparatus comprises an applicator roller that is being supplied with liquid coating, that is being engaged into contact with the sheet substrate, that is transferring coating to the sheet substrate, and that is being sequentially engaged and separated from the sheet substrate with an actuation apparatus operating in concert with the press rotation creating a clearance between the application roller and sheet substrate to allow protruding sheet grippers to pass without interference.

### BACKGROUND OF THE INVENTION

1. Field of the Invention

This invention relates to a coating applicator apparatus incorporated into a rotary sheet-fed printing press that applies coating upon the sheet substrate that is transported by a sheet-carrying cylinder.

2. Background of Prior Art

In many applications it is advantageous to place a coating applicator apparatus after each conventional printing station in an inline printing press to have the capability of applying a base coat for subsequent inline printing, to entrap and shield prior printed wet ink from smearing at downstream processing contacts, to add a surface texture on the finished product and to minimize the need for powder driers at the delivery stack. Ideally, the coating applicator apparatus should not hinder the normal printing process and should be done without adding to the complexities of the sheet substrate travel through the printing press.

A number of prior art add-on coating applicators have been made in an attempt to satisfy the need for an inline coating apparatus. Dahlgren, U.S. Pat. No. 5,178,678 discloses a retractable coating apparatus which includes a special blanket cylinder to apply coating to the sheet substrate carried on the press impression cylinder. The special blanket cylinder is synchronous driven by the press with a clearance gap to miss the sheet grippers on the press impression cylinder. This expensive coating apparatus is space intrusive and must be retracted to perform normal maintenance and print setup. Herbert, U.S. Pat. No. 5,209,179 discloses a coating apparatus utilizing an endless coating plate belt to communicate to a workpiece carried by a press cylinder. The endless coating plate belt and its carrying support roller, has indentation provisions to provide clearance for the sheet grippers on the press cylinder. This feature allows application to the sheet substrate on a press cylinder. The plate belt requires critical care and special maintenance for proper performance. Hess, U.S. Pat. No. 6,272,986 discloses a retractable coating apparatus that encompasses a special plate cylinder that applies coating directly to the sheet substrate on the press impression cylinder. The special plate cylinder is driven in synchronization to the press impression cylinder and includes a clearance gap to clear the sheet grippers on the press impression cylinder. This expensive apparatus is space intrusive and must be retracted for normal plate changes. Komori, U.S. Pat. No. 6,143,074 discloses a coating device that contains a provision to apply coating varnish to a sheet-carrying press cylinder surface which in turn transfers coating to the backside of a sheet substrate. A provision is made to embed the tip end of the sheet grippers inwardly from an outer peripheral face, which allows a small application roller to engage the outer peripheral face without interference of the embedded sheet grippers. To embed the paper grippers inwardly from the normal geometrical travel of the sheet substrate requires a significant press design change.

This invention features a coating apparatus incorporated into a rotary sheet fed printing press to provide a means to apply coating to a sheet substrate that is transported by a press sheet-carrying cylinder. Normally a press sheet-carrying cylinder is equipped with sheet grippers that protrude above the cylinder's surface to clamp the sheet substrate against the cylinder's outer surface. The protrusion of the sheet grippers above the sheet surface restricts the usage of a coater applicator roller applying coating directly to the sheet substrate. This invention overcomes this restriction by including an applicator roller that applies coating upon a sheet substrate and being associated with an actuation apparatus that hurdles the applicator roller over the sheet grippers, preventing a collision.

Preferably the actuation apparatus is powered by a press driven cam operating in concert with the press rotation. The cam linked to the applicator roller engages the application roller to the sheet substrate to transfer coating. At a predetermined rotational position the cam linked to the application roller separates the application roller from the sheet substrate creating clearance for protruding sheet grippers to pass with out interference. Where upon, the cam repeats the cycle for the next sheet substrate in line.

Another actuation apparatus comprises an externally powered actuator linked to the applicator roller to create the required engagement and separation motion. The externally powered actuator's power source can be pneumatic, hydraulic, or electrical. An electrical or mechanical switch in operative with the press rotational position signals the externally powered actuator for proper sequence of engagement and separation action.

Another method comprises a tensioned torsion spring linked to the applicator roller to produce the required engagement and separation action. The engagement and separation limits are controlled by a ratchet and pawl to stop motion at either the engaged position or the separated position. One ratchet and pawl for the engaged limit and one ratchet and pawl for the separated limit can best control the engaged and separated positions. Releasing a pawl permits the torsion spring to index to the next stop of the ratchet. The pawl release actuators can be powered pneumatically, hydraulically, or electrically. An electrical or mechanical switch in operative with the press rotational position signals the pawl release actuators for proper sequence of engaged or separated action. The torsion spring is wound into tension by a motor geared to the torsion spring. Input to the motor can be pneumatic, hydraulic, or electrical.

It should be noted that this invention requires an apparatus to supply liquid coating to the applicator roller for distribution to the sheet substrate. There are known prior art mechanisms that can be utilized. Preferably an anilox roller driven at or near press surface speed equipped with a chambered doctor blade and necessary plumbing equipment is best suited for this invention.

It should also be noted that a suitable dryer means should be applied to the sheet substrate after it has received the coating. An infra-red radiation dryer is a suitable choice for many applications.

It should be emphasized that the full benefits of this invention is obtained if one applicator apparatus is applied after each print station in a multicolor inline printing press. This invention is intended to be an integral part of a printing press, however an existing printing press can be retrofitted to include this invention.

It should be pointed out that the term “coating” as used herein, refers to, but not limited to, a liquid film-forming vehicle that can include aqueous dispersed resin, ultra-violet curable ink, or varnish. The term “rotary sheet fed press” as used herein can include “offset lithographic” or “flexographic”.

### BRIEF DESCRIPTION OF THE DRAWINGS

FIG. 1 is a partial layout of a typical sheet fed rotary printing press showing the preferred location of the present invention.

FIG. 2 is a perspective view showing the present invention with a press driven cam actuation apparatus.

FIG. 3 is a perspective view showing the present invention with an actuator driven actuation apparatus.

FIG. 4 is a perspective view showing the present invention with a tensioned torque spring actuation apparatus.

### DETAILED DESCRIPTION OF THE INVENTION

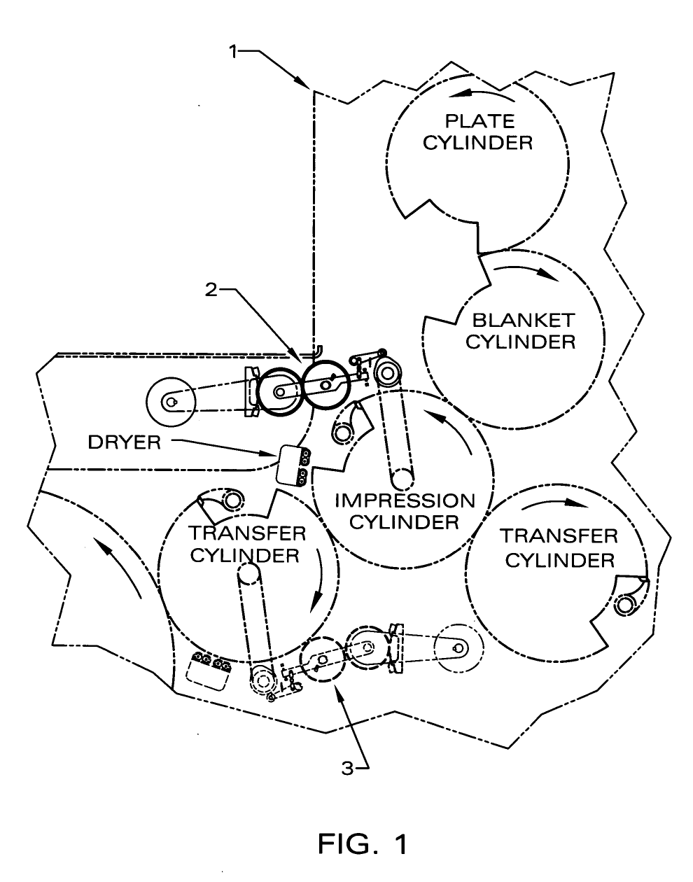

This invention is a new and improved coating applicator apparatus that applies coating to the sheet substrate being transported by a sheet-carrying cylinder in rotary sheet fed printing presses. FIG. 1 shows a partial layout of a typical sheet fed rotary printing press 1 with the preferred embodiment placement 2 of the invention. An alternate placement 3 is shown.

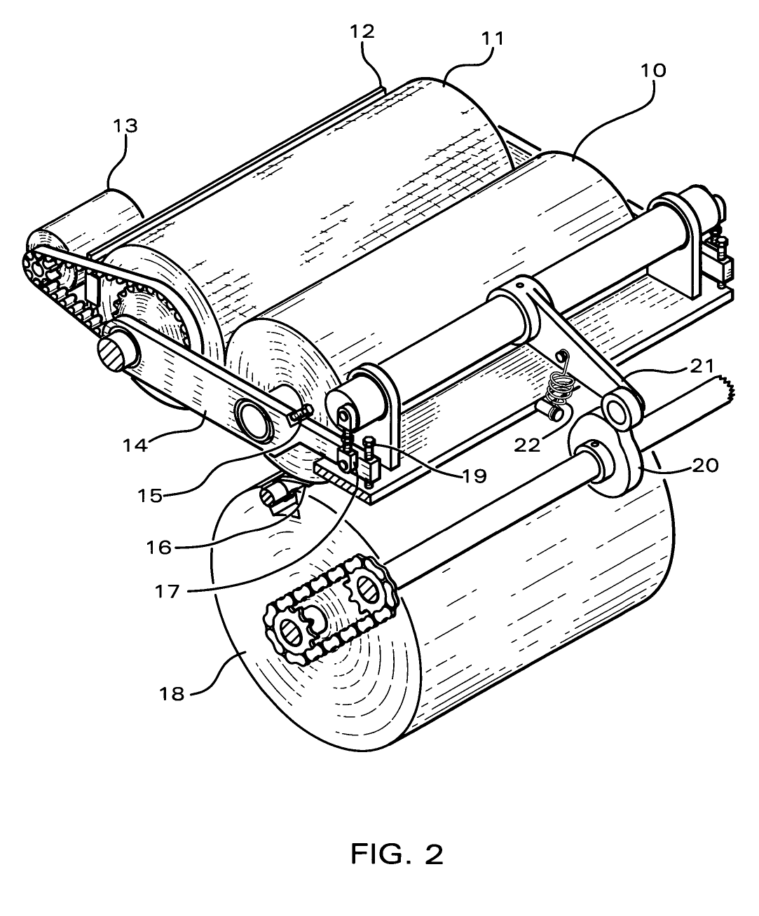

FIG. 2, Illustrates the functional aspects of the invention. Applicator roller 10 is covered with a relatively soft rubber material with an approximate hardness of durometer shore A:25. The soft surface reduces the tendency for the roller to bounce when coming into contact with the sheet substrate against the press cylinder. For the coating supply means an engraved anilox roller 11 is best suited for this invention. The anilox roller 11 can be engraved to approximately 200 lpi with a volume of 10 bcm. This can be varied for a particular coating requirement. A complete anilox roller system including a chambered doctor blade 12 with a cleaning apparatus can be purchased from Harris & Bruno Inc., Roseville, Calif. The chambered doctor blade system is described in U.S. Pat. No. 6,576,059. The anilox roller can be driven by an electrical motor 13 to match the surface speed of the press printing cylinders to within plus or minus 10%. The applicator roller 10 attached to frame 14 can pivotally move while maintaining contact with the anilox roller 11. An adjustment screw 15 maintains the proper contact between applicator roller 10 and anilox roller 11. The illustration is showing the applicator roller 10 in the separated mode. Note that the applicator roller 10 is clearing the paper gripper 16. With proper adjustment of link 17 and on-stop screw 19 contact can be controlled between applicator roller 10 and the sheet substrate on press cylinder 18 during the engaged mode. The press driven cam 20 that is linked to the applicator roller 10 through arm 21 provides the motion necessary for coating the sheet substrate and then separating the applicator roller 10 to clear the sheet grippers 16. A spring 22 maintains contact between arm 21 and the press driven cam 20.

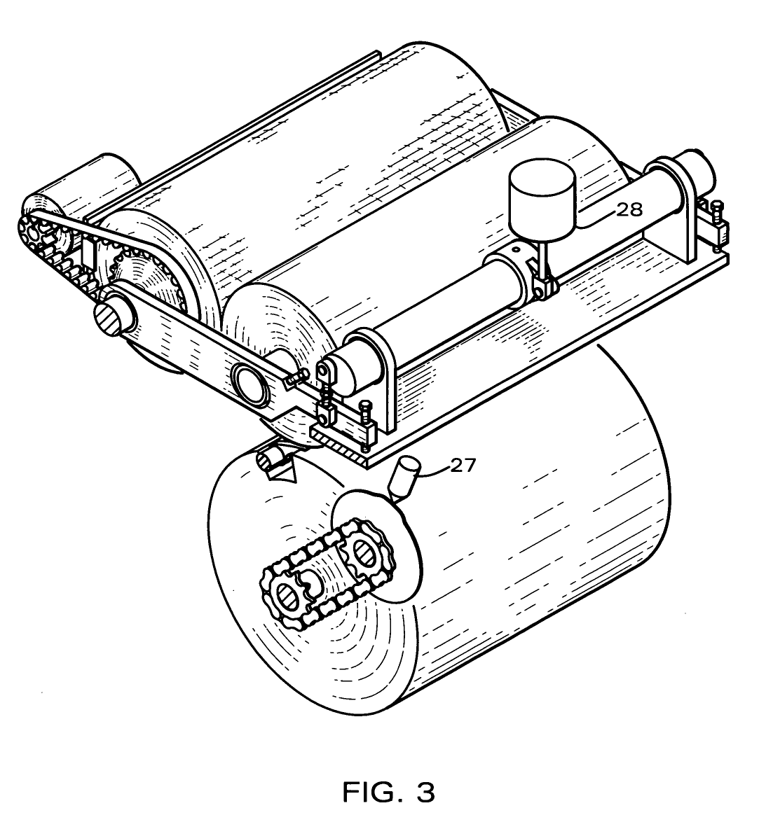

FIG. 3 Illustrates an actuation apparatus comprising an externally powered actuator 28 to create the required engaging and separating motion. The externally powered actuator's power source can be pneumatic, hydraulic, or electrical. A mechanical or an electrical activation apparatus 27 operative with the press rotational position signals the externally powered actuator for proper sequence of engaging and separating action.

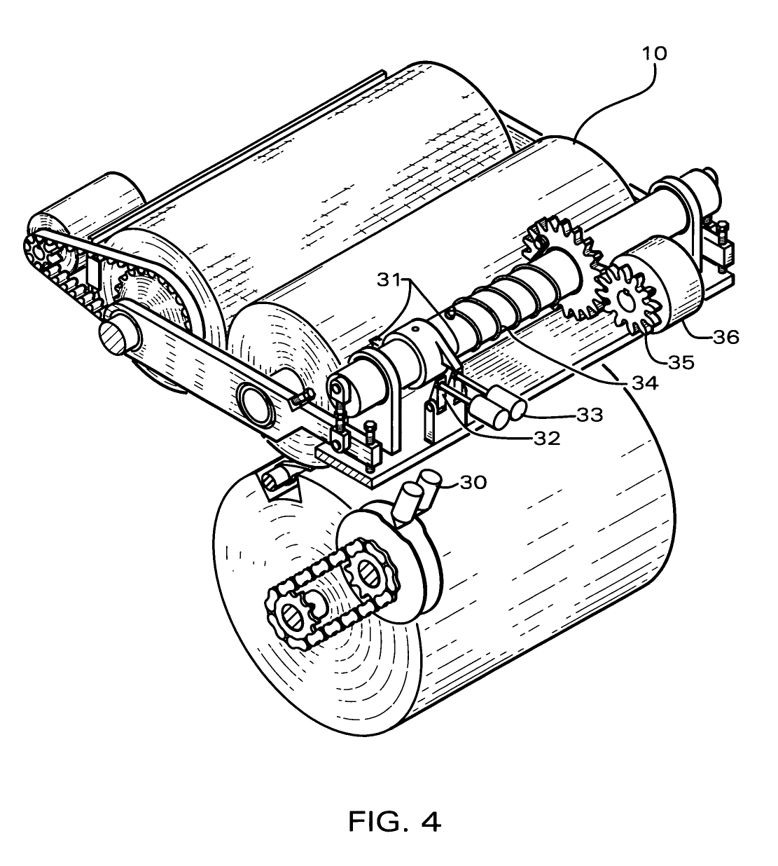

FIG. 4 Illustrates an actuation apparatus comprising a tensioned torsion spring 34 linked to the applicator roller 10 to produce the required engaging and separating action. The engaged and separated limits are controlled by a ratchet 31 and pawl 32 to stop motion at either the engaged position or the separated position. One ratchet and pawl for the engaged limit and one ratchet and pawl for the separated limit can best control the engaged and separated positions. The pawl release actuators 33 can be powered pneumatically, hydraulically, or electrically. A mechanical or an electrical activation apparatus 30 in operative with the press rotational position signals the pawl release actuators for proper sequence of the engaged position or the separated position. The torsion spring is wound into tension by a motor 36 geared 35 to the torsion spring 34. Input to the motor can be pneumatic, hydraulic, or electrical.

I claim:

1. A coating applicator apparatus having a means to apply coating upon a sheet substrate that is being transported by a sheet-carrying cylinder in a rotary sheet fed press comprising:
a liquid coating supply transferable to an applicator roller,
an applicator roller mounted on movable supports enabling engagement and separation of the applicator roller to the sheet substrate,
an actuation means linked to the applicator roller providing engagement and separation motion to the applicator roller in operative concert with the press rotation enabling the applicator roller to engage the sheet substrate to transfer coating then creating separation clearance for protruding sheet grippers to pass without interference.

2. The coating applicator apparatus of claim 1 wherein the liquid coating supply comprises an anilox roller and a chambered doctor blade association to provide the liquid supply transferable to the applicator roller.

3. The coating applicator apparatus of claim 1 wherein the movable supports are pivotal about an anilox roller enabling a continuous contact between the anilox roller and applicator roller as the applicator roller engages and separates from the sheet substrate.

4. The coating applicator apparatus of claim 1 wherein the actuation means comprises a press driven cam in synchronization with the press rotation.

5. The coating applicator apparatus of claim 1 wherein the actuation means comprises a pneumatic powered actuator.

6. The coating applicator apparatus of claim 1 wherein the actuation means comprises a hydraulic powered actuator.

7. The coating applicator apparatus of claim 1 wherein the actuation means comprises an electrical powered actuator.

8. The coating applicator apparatus of claim 1 wherein the actuation means comprises a torsion spring wound into tension with a pneumatic motor.

9. The coating applicator apparatus of claim 1 wherein the sheet-carrying cylinder is an impression cylinder.

10. The coating applicator apparatus of claim 1 wherein the sheet-carrying cylinder is a transfer cylinder.

11. The anilox roller of claim 2 wherein the anilox roller is driven by an electric motor to match or near match the printing press surface speed.
